(19) United States
(12) Patent Application Publication
(10) Pub. No.: US 2015/0293752 A1
(43) Pub. Date: Oct. 15, 2015

(54) Unrestricted, Fully-Source-Preserving, Concurrent, Wait-Free, Synchronization-Free, Fully-Error-Handling Frontend With Inline Schedule Of Tasks And Constant-Space Buffers

(71) Applicant: Pradeep Varma, Gurgaon (IN)

(72) Inventor: Pradeep Varma, Gurgaon (IN)

(21) Appl. No.: 14/673,231

(22) Filed: Mar. 30, 2015

(30) Foreign Application Priority Data
Apr. 11, 2014 (IN) 1025/DEL/2014

(51) Int. Cl. G06F 9/45; G06F 9/46

(52) U.S. Cl. CPC G06F 8/456; G06F 9/467

(57) ABSTRACT

A concurrent, wait-free compiler/compiler front-end for C/C++ and other programming languages, comprising parallel stages that carry out the steps of character translation, line translation, macro rewriting, lexing, parsing, and handling errors in input text and translating it to an object form, with features including (a) long lexenes, (b) display modifiers, (c) look ahead isolation, (d) line-by-line processing followed by tokenization, (e) complete error handlers, and/or (f) precise and inline context switches.

### FIELD OF INVENTION

This disclosure is about compilers or compiler frontends in general and C/C++ compilers or compiler frontends in particular.

### BACKGROUND OF THE INVENTION

As given in Section 5.1.1.2 of C11 [5] and C99 [3], and very similarly in Section 2.2 of C++11 [4] and Section 2.1 of C++98 [2], compilation and linking of a source program comprises of a sequence of 8 (C99/C11) or 9 (C++98/C++11) translation phases. Of these, the first 6 phases and partly 7 make up the frontend of a C/C++ compiler. These 7 translation phases for C11/C99 are reproduced verbatim from Section 5.1.1.2 of the C99/C11 language standards below.

Translation Phases for C99/C11
1. Physical source file multibyte characters are mapped, in an implementation-defined manner, to the source character set (introducing new-line characters for end of-line indicators) if necessary. Trigraph sequences are replaced by corresponding single-character internal representations.
2. Each instance of a backslash character (\) immediately followed by a new-line character is deleted, splicing physical source lines to form logical source lines. Only the last backslash on any physical source line shall be eligible for being part of such a splice. A source file that is not empty shall end in a new-line character, which shall not be immediately preceded by a backslash character before any such splicing takes place.
3. The source file is decomposed into pre-processing tokens and sequences of white-space characters (including comments). A source file shall not end in a partial pre-processing token or in a partial comment. Each comment is replaced by one space character. Newline characters are retained. Whether each nonempty sequence of white-space characters other than newline is retained or replaced by one space character is implementation-defined.
4. Pre-processing directives are executed, macro invocations are expanded, and Pragma unary operator expressions are executed. If a character sequence that matches the syntax of a universal character name is produced by token concatenation (as per section 6.10.3.3), the behavior is undefined. A #include pre-processing directive causes the named header or source file to be processed from phase 1 through phase 4, recursively. All pre-processing directives are then deleted.
5. Each source character set member and escape sequence in character constants and string literals is converted to the corresponding member of the execution character set; if there is no corresponding member, it is converted to an implementation-defined member other than the null (wide) character.
6. Adjacent string literal tokens are concatenated.
7. White-space characters separating tokens are no longer significant. Each pre-processing token is converted into a token. The resulting tokens are syntactically and semantically analyzed and translated as a translation unit.

Restrictions: In implementing a compiler/compiler frontend, the C99/C11 standards (in Section 5.2.4.1, Translation Limits) allow several simplifications or restrictions on acceptable source programs such as only 63 significant initial characters in an internal identifier or macro name, 31 significant initial characters in an external identifier, 4095 characters in a logical source line, 4095 characters in a string literal (after concatenation). These translation limits, in Section 5.2.4.1 of C11 [5] and C99 [3] are intended to simplify the task of building an efficient C/C++ compiler (especially memory efficient compiler, see C99 rationale V.5.10) at the cost of arbitrarily cutting down the set of legitimate C/C++ programs. A compiler restricted to a translation limit, becomes incapable of emulating another compiler with a larger translation limit. A compiler without any translation limit then, is capable of emulating all compilers with translation limits.

A compiler without translation limits is desirable, as it can process all programs processed by compilers with translation limits.

As the translation phases described above show, the task of writing a C/C++ compiler is not expected to have the ambition of comprehensive representation of a program's source-code, as evidenced by allowing comments and whitespace to be dropped in favour of one space character. Support for comment and whitespace tokens implies support for lexemes of arbitrary length (unlike capped-length identifiers), as a comment or whitespace can easily be very long. The need for accessing the entirety of a program's sources is most common in source-to-source transformation systems whose output needs to preserve the original code as is, including its comments, for ease of user recognition. An example of a source-to-source transformation system that provides access to source code in original form is the porting/maintenance system of [6, 7]. This system concedes inadequacy of the internal program representation constructed by a compiler frontend and obtains source code entirety by direct look up of the program source files (as anchored text) additionally to the internal program representation obtained from a compiler frontend. This system itself would benefit if the internal program representation made available to it by the compiler frontend were made comprehensive, or in other words, an ideal source-preserving frontend were provided to it.

### SUMMARY OF THE INVENTION

In accordance with an embodiment of the present subject matter, the present invention describes a concurrent, wait-free compiler/compiler front-end method, comprising parallel stages that carry out the steps of character translation, line translation, macro rewriting, lexing, parsing, and handling errors in input text and translating it to an object form.

In another embodiment, the present invention describes a compiler/compiler front-end method that carry out the steps of character translation, line translation, macro rewriting, lexing, parsing, and handling errors in input text and translating it to an object form where the entire input is represented in the object form including whitespace such as comments, display alternatives such as trigraphs and line joins, original directives and macros, and a record of error corrections.

In yet another embodiment, the present invention describes a concurrent, lock-free compiler/compiler front-end method, comprising parallel stages that carry out the steps of character translation, line translation, macro rewriting, lexing, parsing, and handling errors in input text and translating it to an object form.

In yet another embodiment, the present invention describes a wait-free concurrent allocator supporting a priori unknown-sized contiguous-space allocations and fixed-sized contiguous-space allocations, wherein an unknown sized allocation is carried out by an initial space allocation, an optional sequence of continued more-space requests, and an optional return excess space request.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present invention will become better understood when the following detailed description is read with reference to the accompanying drawings in which like characters represent like elements throughout the drawings, wherein:

FIG. 1 illustrates two buffered stages with a lookahead pre-processor, in accordance with an embodiment of the present subject matter.

FIG. 2 illustrates a pseudocode showing the working of the line-by-line processing in a first stage, in accordance with an embodiment of the present subject matter.

FIG. 3 illustrates a join stack lookahead pre-processing carried out as a preamble to the line-by-line processor in the same stage, in accordance with an embodiment of the present subject matter.

FIG. 4 illustrates a main loop of a tokenizer stage, in accordance with an embodiment of the present subject matter.

FIG. 5 illustrates a rule body for identifier as an example of tokenizer rules, in accordance with an embodiment of the present subject matter.

FIG. 6 illustrates the working of a collaborative space allocator, in accordance with an embodiment of the present subject matter.

FIG. 7 illustrates a process for space reclamation, in accordance with an embodiment of the present subject matter.

FIG. 8 illustrates a block diagram of a system configured to implement the method in accordance with one aspect of the description.

FIG. 9 illustrates a block diagram of a system configured to implement the invention in accordance with a parallel, shared memory aspect of the description.

FIG. 10 illustrates a block diagram of a system configured to implement the invention in accordance with a parallel, distributed memory aspect of the description.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of block diagrams, one or more components therein may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated method, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method.

Unless otherwise defined, all technical and scientific terms used herein have the same meaning as commonly understood by one of ordinary skill in the art to which this invention belongs. The methods and examples provided herein are illustrative only and not intended to be limiting.

In view of the description as provided in the background section, it is desirable to provide a method of building a compiler frontend or compiler that internalizes (as tokens or abstract syntax tree (AST) nodes), the entirety of a source program comprising whitespace, comments, character presentations (viz. trigraphs) and line presentations (viz. joins of all varieties, where a simple join is a preceding a newline character signifying a splice of the two lines). A test for successful internalization of a program is that the system be capable of printing or pretty-printing out as output, exactly the same program provided as its input. The method additionally should not place restrictions on input programs, such as identifier sizes, line sizes, string sizes etc. discussed above. The method should be efficient, especially, memory efficient, so as to be able to run in small memory contexts as well as speedily. Memory efficiency is most capably met if the compiler works within small, constant size buffers. The system should context switch between its translation phases or modules with minimum overhead a minimum number of times while progressing through the program using constant-space buffers and storing the internalized program without memory wastage. Cheapest context switches are availed of if they are inlinable switches comprising sequential/standard language constructs such as function calls and returns, as opposed to the creation and management of a task and threads mechanism in a serialized/sequentialized implementation of the system. Speedy processing is provided, if the system does not duplicate any effort as it computes its result. A program provided as input can easily be malformed, so the system should endeavour to continue processing the program after identifying discovered errors so that it advises the user of such errors and warnings in one comprehensive final report on the program. For this to transpire, an error may require automatic fixing (with the user informed of the fix) so that the compiler can continue its progress. Ideally, with fixes, the progress through arbitrary input will never stop except at the end of the program and will alter the program little in bringing it to a recognizable form. A system with such capabilities may be said to have the capability of handling all program errors fully.

Keeping in view the above, the present invention accordingly, discloses a concurrent, wait-free compiler/compiler front-end, comprising parallel stages that carry out the steps of character translation, line translation, macro rewriting, lexing, parsing, and handling errors in input text and translating it to an object form.

In an embodiment of the present invention, the method is carried out using constant-space buffers between stages and a memory allocator for allocating memory proportional to the size of the program input including expanded macros and included files.

In another embodiment of the present invention, the method is carried out using constant memory for buffers and a recycling memory allocator.

In yet another embodiment of the present invention, the method is carried out using constant memory for the stack and the method code.

In still another embodiment of the present invention, the method is carried out using only single-writer registers of parallel shared memory machines and no synchronization constructs.

In a further embodiment of the present invention, the method is optionally carried out by monotonically increasing structures without node or token removals.

In an embodiment of the present invention, the method is carried out using only registers of a uniprocessor machine and no synchronization constructs in a serialized implementation of the concurrent stages.

In another embodiment of the present invention, the method is carried out such that context switches between stages are minimal and inlined in a serialized schedule.

In yet another embodiment of the present invention, the method is carried out such that the concurrent stages can tolerate all syntactic input text errors and progress through the entire input to either translate it or report on errors.

In still another embodiment of the present invention, the method is carried out such that errors are minimized by not placing syntactic translation limits such as lexeme size or line length on the input.

In a further embodiment of the present invention, the method is carried out such that each work per stage is unique and no redundancy or work duplication is involved.

In a furthermore embodiment of the present invention, the method is carried out with minimal contention/communication realization on cached PRAM (parallel random access memory—shared memory) and all distributed memory models comprising first-in-first-out (FIFO) order data communication from a one-writer stage memory to a reader-stage memory in a static mapping of stages to processors minimizing communication cost.

In another embodiment of the present invention, the method supports C/C++ and Java.

In addition to the above, the present invention also provides a compiler/compiler front-end that carry out the steps of character translation, line translation, macro rewriting, lexing, parsing, and handling errors in input text and translating it to an object form where the entire input is represented in the object form including whitespace such as comments, display alternatives such as trigraphs and line joins, original directives and macros, and a record of error corrections.

In an embodiment of the present invention, the method is carried out with unknown look ahead needs dealt with earliest in an initial stage of the compiler.

In another embodiment of the present invention, the method is carried out such that the input can be regenerated from the object form in printing or pretty printing it.

In yet another embodiment of the present invention, the method is carried out such that display alternatives and error corrections are tracked using display tokens.

In still another embodiment of the present invention, the method is carried out such that display tokens allow concurrent read and write by distancing single writers using marker tokens.

In a further embodiment of the present invention, the method is carried out such that deletions are implemented by marking a token or node as such instead of actual removal.

In addition to what has been indicated above, the present invention also provides a concurrent, lock-free compiler/compiler front-end, comprising parallel stages that carry out the steps of character translation, line translation, macro rewriting, lexing, parsing, and handling errors in input text and translating it to an object form.

In a further embodiment of the present invention, the method uses only single-writer registers of parallel shared memory machines and no synchronization constructs.

Additionally, the present invention provides a wait-free concurrent allocator supporting apriori unknown-sized contiguous-space allocations and fixed-sized contiguous-space allocations, wherein an unknown sized allocation is carried out by an initial space allocation, an optional sequence of continued more-space requests, and an optional return excess space request.

In an embodiment of the present invention, the allocator is organized as a list of memory blocks sorted by size, with unknown-space allocations starting from the top of the largest end and fixed-size allocations starting from the bottom of the smallest end.

In another embodiment of the present invention, wherein the allocator is organized using only single-writer registers of parallel shared memory machines and no synchronization constructs.

In another embodiment of the present invention, wherein the allocator is organized with one concurrent stage implementing the allocator function and allocating chunks to others.

In another embodiment of the present invention, wherein the allocator supports bulk concurrent recycling of unknown-size and/or known-size allocations such that contiguous space behind live allocations is freed up and a recycling boundary chases an allocation boundary around the sorted memory blocks for each kind of allocation (known/unknown size).

In this disclosure, we present a method for building a compiler or compiler frontend that:

1. Represents or internalizes as tokens/AST nodes, the entire source code of a program comprehensively. The print/pretty print of an internalized program is identical to the input program.

2. Is unrestricted, by not placing translation limits such as lexeme or line size allowed by language standards on them. The translation of an input program in this system stops prematurely only if the system runs out of memory while translating and representing a large program.

3. Fully handles all errors in an input program by minimal fixes such as inserting an ending ” for an incomplete string at a new line or a closing */ for an incomplete comment at end of file. The system progresses through arbitrary input completely, unless it runs out of memory as mentioned above.

4. Is efficient in working exclusively with:

(a) Constant-space buffers that can be set to a small size. The memory required for translating and internally representing a program of b bytes (including macros and macro expansions and #includes and file insertions) is proportional to b, viz. of the form k₁b+k₂, where k₁ and k₂ are small constants. This translation and processing memory includes all the stack, heap, and translator code (frontend/compiler code) memory required for the computation. In short, the use of only constant buffers and bounded recursion/function calls in the program and minimal comprehensive representation of the source allows the memory use of the computation to be characterised thus.

(b) No duplication of effort from one translation phase to another all the way down to the recognition of a last lexeme.

(c) Concurrent implementation of translation phases/modules with context switches that are all inlined and minimum in number so that realizations of the system, such as a serialized/sequential implementation, have minimal associated cost.

Given 2 and 3 above, assuming large memory, the system may be said to have complete tolerance of all program input, by first allowing the expression of unlimited syntactic constructs in the program, and thereafter handling all errors in program input. Furthermore, all the objects in the system are exclusively wait-free objects, ensuring that each concurrent thread/module in the system makes progress regardless of the status of others. Our teaching thus provides the first wait-free compiler system in the literature. As a corollary, our teaching also provides the first lock-free compiler system in the literature. All the wait-free objects in the system are constructed with minimal synchronization needs, relying exclusively on atomic registers or less to attain the result. Atomic registers are the basic memory unit of the shared memory parallel computation model (PRAM—parallel, random access memory). No synchronization constructs such as locks are used in the system. On atomic registers, our system imposes minimal requirements, viz. requiring single-writer, multi-reader registers at most. This in turn loads a PRAM shared memory machine the least, supporting efficient realization on stock hardware or virtual implementations thereof such as DSMs (distributed shared memory), software implementations of cache coherence, etc. As a baseline, we show how a parallel, privatized memory realization of our system can be made, with minimal communication overhead/network contention, assuming only pipelined communicating buffers between threads with private memory. Thus systolic, raw, ASIC, FPGA realizations of our system are attainable with very high efficiency.

Solution

The system we present here, called Magic (for Modern Era General Intelligent C/C++) has the following design features:

1. Long Lexemes

The tokens or lexemes constructed by our system can be arbitrarily long and represent arbitrary amount of text from the source program. Thus no translation limits are assumed and tokens such as identifiers, comments, whitespace, strings, header names etc. can be arbitarily long. To support this feature, buffer for identifying a lexeme has to allow the lexeme to span more than one bufferful of characters. This differs from the small, buffer-bounded lexeme scheme presented in prior art [1], wherein a current lexeme is contained in a constant-space buffer between lexeme beginning and forward pointers. In allowing a lexeme to span multiple bufferfuls, in Magic, the lexeme beginning pointer is moved forward periodically and the characters passed over saved from the buffer into a token under construction. When the token is fully constructed, both the lexeme beginning and forward pointers move on the next lexeme in the buffer. In carrying this out efficiently, the token under construction does not even have a priori knowledge of the space it will consume. Hence even its initial space allocation in the memory management routine is unknown till the end of the construction. The memory allocator in Magic is thus a custom allocator that is dedicated to the compiler. Upon request, the allocator carries out an intial allocation for a token and continues incrementing that allocation till a token complete is signalled. For this, the allocator allocates from its largest available block of memory till either the token completes or the memory runs out. The allocator is a part of the teaching presented here and is described in detail later. The collaborative allocation feature of the allocator presented here may be used independently of the frontend in other memory allocation contexts and thus is an independent feature of this teaching.

2. Display Modifiers

The language being compiled may permit multiple alternative equivalent presentations of source code text. For example, in C/C++, a character like \ may be presented as itself, or as the trigraph sequence ??/. A line may be presented as itself, or as two joined lines, wherein the new-line character of the first line is preceded by a \ character signifying a splice. Since Magic seeks comprehensive source code representation, the specific display choice for all sequences and sub-sequences of source code text are captured by it as display modifier tokens. These tokens are in addition to lexeme tokens and include modifications for error-handling edits carried out by Magic such as text insertions and deletions. The complete token stream generated by Magic, including the display modifiers, when pretty printed, regenerates the original source code as the printing of the token stream is informed by the display modifiers to make the appropriate printing decisions.

3. Lookahead Isolation, Line-By-Line Processing Followed By Tokenization

In C/C++ and many languages, several translation decisions are taken on a line-by-line basis e.g. a // comment is terminated by a newline, a string cannot span multiple lines in source code (viz. have intervening newlines in text), which implies that a matching closing ” has to be found for a string before a newline. The case for characters and header names is similar to strings. A long comment (viz. /* . . . */) by contrast can span multiple lines. When a comment is under processing, a ” does not imply the start of string processing. And so on. Errors are often identified earliest on a line-by-line basis, e.g. when a newline is encountered prior to a closing ” for a string. In Magic, lightweight line-by-line processing is one of the main stages of translation, with its own input buffer and output buffer. Line-by-line processing is followed by a lightweight tokenization stage, which takes as input the output buffer of line-by-line processing and constructs tokens for further use in the compiler. Line-by line processing works with constant character lookahead (two or more, depending upon presence of trigraphs in the input), tokenization is similar, with no trigraph issues as they have been translated away in the earlier stage. Preceding line-by-line processing, as a part of pre-processing for the same stage, is a join-stack analyser that works with arbitrary character lookahead on the input buffer. This arbitrary character lookahead can be forced by a sequence of n \ characters (as characters or trigraphs) followed by a sequence of m newline characters. In this, up to the last m of the n \ characters get used in the join stack with the earlier ones remaining unused, as ordinary characters in the source code. The decision as to which of the n \s are a part of the join stack cannot be made till the last of the mth newline has been seen. The join stack is an uncommon pattern, since in power it is equivalent to a simple join comprising one \ and one newline. Regardless, its arbitrary lookahead requirement is isolated in Magic as pre-processing of the line-by-line processor's input, advancing it as and when necessary to achieve the result.

4. Complete Error Handlers

Magic ensures that regardless of the text input, it is able to progress through the program till end of file and tokenize the input. This maximizes the totality of a program available for complete compilation, so that the compilation report generated for a program covers as much of the input as possible.

5. Precise, Inlined Context Switches

The two-stage with longlookahead pre-processor structure of Magic, with two constant-space buffers, progresses concurrently and efficiently through an input program with context switches occuring minimally, at buffer empty or buffer full points. Additional stages use the tokens output by these two stages, in sequence or concurrence with them (e.g. the pretty printer). Since, stage computation is often contextually driven, e.g. header processing, where knowledge of # and include tokens preceding a string discriminate a header from an ordinary string, stages are capable of further context switches, gently on demand, to let a lagging stage play catchup and compute this information as it ordinarily would, as opposed to duplicating the computation in the other stage. Finally, all the context switches are extremely lightweight—they are inlined in code, viz. comprised of simple function calls or returns etc.

The teaching presented here is cognizant of and builds on the compiler structure proposed in prior art [1] with additional goals of comprehensive source coverage, etc. mentioned above.

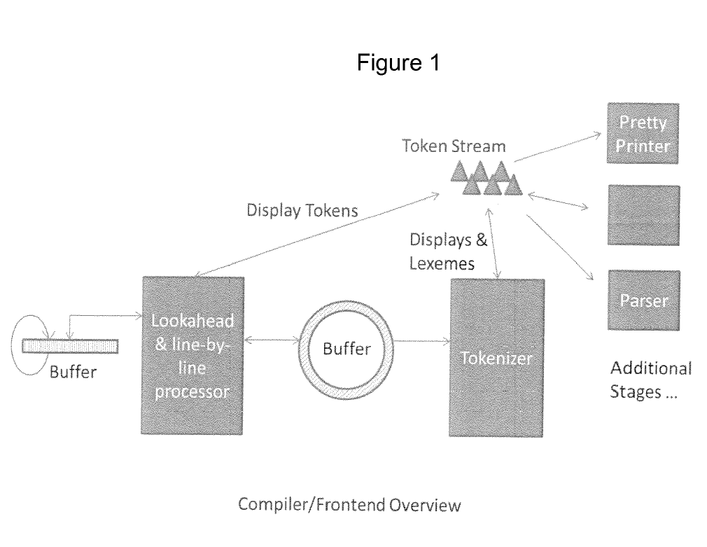

The details of the method presented herein are described now with respect to FIGS. 1-6 as follows:

FIG. 1 shows the two buffered stages with lookahead pre-processor as they compute tokens including long lexemes and display modifiers including join stacks. Additional stages consume the tokens produced by these stages for further compilation and pretty printing. The input buffer, shown on the left, is filled by text read from the source code file (or any alternative means of providing the program to the compiler). This filling is carried out by the line-by-line processor stage, although it may also be carried out in parallel as a separate stage to leverage parallel hardware. The constant-space input buffer comprises one-or-more constant-space blocks of memory. Each block is an array of contiguous locations and non-circular in organization. In a block, the input file may be read in line by line by a common routine such as fgets( ). This fills the block with a whole line, or a chunk bounded by block size (for a long line). The sequence of blocks comprising the buffer is organized circularly, so after the last block has been filled, the first block is reused for filling next. This circular organization is of particular interest to a parallel file reader which may fill the input buffer asynchronously (both reading and writing of independent blocks occurs in parallel). In a sequential implementation of the file reader (say within the line-by-line processor stage), a single block may span the entire buffer.

File reading is succeeded by the first stage pre-processing a block for join stacks first. This is followed by line or line-chunk processing by the stage. The output of the stage is written into a second buffer and represents a much simplified version of the input represented in the source character set, stripped of display peculiarities like joins and trigraphs, and line-by-line errors like missing closing ”, last newline, etc. The second buffer is organized circularly, using a contiguous block of locations. The pointers of the buffer reading stage (tokenizer) and buffer writing stage (first stage) chase each other around the circle, with the consumer blocking when its pointer catches up with the other (buffer empty) or the producer does the dual (buffer full).

Display peculiarities handled by the two stages are tokenized independently by them for addition to the output token stream. The output token stream is shown as a sequence of triangles in the figure. As shown, the token stream comprises the display tokens and lexeme tokens created by the two stages. Lexemes are created by the second stage only, and include long lexemes like comments and identifiers, and short (fixed-size) lexemes like punctuators. The token stream is also read by the two stages for context computation, such as for header names. The token stream output comprises the entire input program (file, by file) and is read by later stages for further compilation or pretty printing. These later stages may also modify the tokens and/or copy them as the processing proceeds.

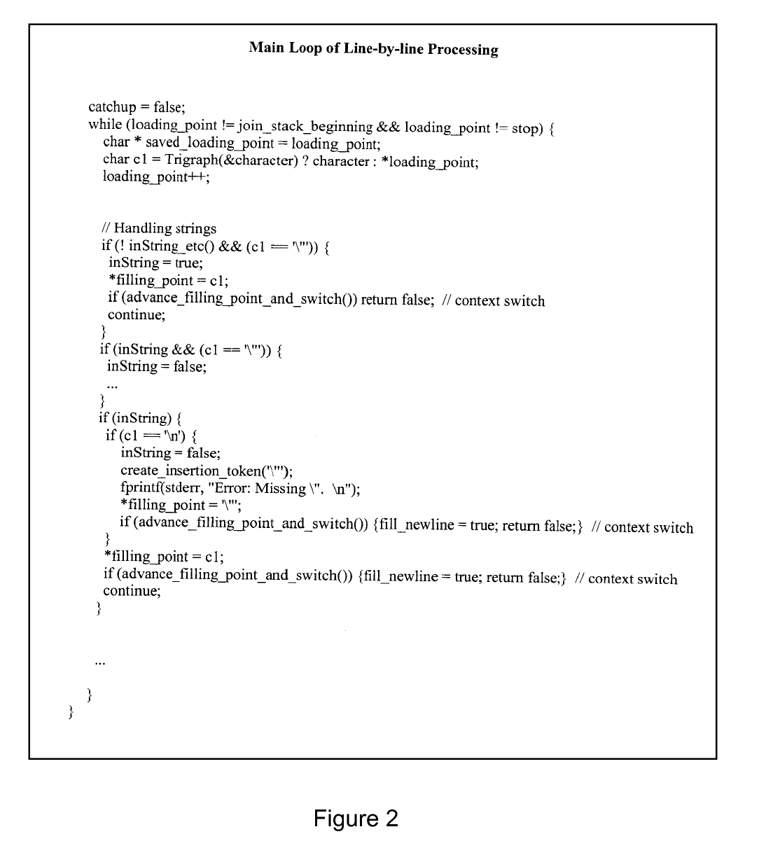

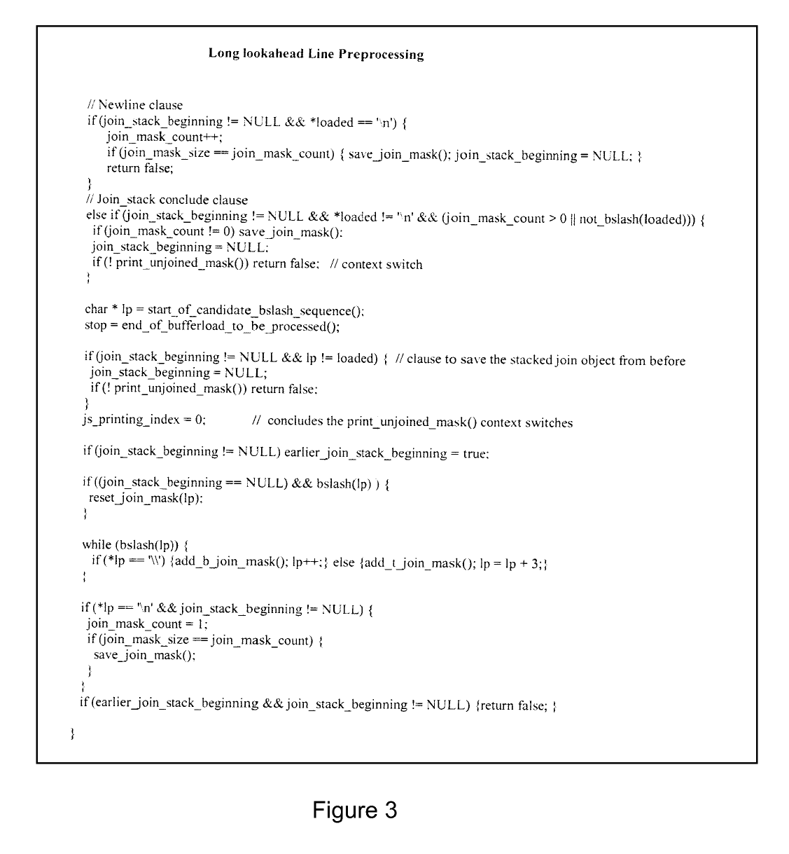

FIG. 2 comprises pseudocode showing the working of the line-by-line processing in stage 1. Line-by-line processor loops through a line or line chunk present in an input buffer block using loading point as buffer pointer. The looping is carried out from the beginning of the chunk or line till a join-stack that may begin in the line. The join stack is identified by join stack beginning pointer, which either points to NULL (no join stack), or a location in the buffer. This pointer is set by the lookahead pre-processor (FIG. 3), prior to the line-by-line processor. If join stack beginning is NULL, the looping ends at stop, which identifies the last character to be handled within the line or chunk, such as just past a newline character, or in case of a line chunk, just before the beginning of a trigraph that may have been chopped midway at the end of the line chunk. This chopped trigraph is then left to be processed at the beginning of the next line chunk, later.

The body of the loop runs through rules pertinent to line-by line processing such as handling strings (which must have a closing ”within the line), characters, and headers (all closed within the line), and comments. A line comment (begun by //) is closed at the newline character and a comment, long or line (viz. // or /* . . . */) disables the other rules.

A default rule handles the characters not belonging to other rules (copies the characters, after display processing, in source character set representation to the output buffer). The rules work within constant character lookahead in buffer. The first character, c1, is obtained within three character lookahead after trigraph processing. A second character is looked up if needed (e.g. by a comment rule), by dereferencing loading point after it has been advanced past the first character (or its trigraph).

The rules also look up the output buffer and/or token stream, if needed, for contextual processing of the rules. For instance, header name processing requires both to be looked up for # and include preceding a string input.

As a detailed example, the rule for strings is shown in FIG. 2. The rule has three clauses. The first clause checks for a prior context, e.g. ongoing comment, string processing etc., and then if not, then for the input character (c1) being a ”, begins the string processing by flagging a string context (setting inString to true). The character is then copied to the output buffer at the present location of the output buffer pointer, filling point. The output buffer pointer is advanced and the loop continued unless the output buffer is full at which point the stage cedes computation by undergoing a context switch so that the other stage can consume the buffer and make space for the line-by-line processor. Note that the context switch comprises only a procedure return for the line-by-line processor, after which, within a constant number of minor C/C++ steps like procedure and loop return, the control is resumed by the tokenizer stage in its ongoing loop.

The second clause of string processing reacts to a closing ” character in the input text and carries out the same steps as the first clause except setting inString to false. The third clause reacts to the body of the string. In this, if a newline character is encountered, an insertion of a ” character to close the string is carried out and inString is set to false. In case a context switch takes place after the ” insertion, fill newline is flagged so that later when this stage resumes, it remembers to insert the newline character that the buffer pointer loading point has already moved past.

The string rule in FIG. 2 is simplified by ignoring details like escape sequences e.g. \” within the string body. One method [claim] of handling an escape sequence is to track it using a boolean variable initialized to false that toggles each time a \ is encountered. A ” encountered when the variable is true is escaped (does not close a string), otherwise it is not (closes the ongoing string). This method has an advantage of requiring only a one-character lookahead (c1) at a time.

The rule for a header name is similar to the string rule, except that it has an extra clause in the beginning that becomes eligible after the output buffer has been initialized with one or more characters and a candidate opening ” is encountered with the forward pointer being behind filling point (i.e. buffer is not empty and tokenizer can proceed). In this case, the line-by-line processor cedes control (context switches), setting a boolean flag catchup to true that allows it to later jump straight to the line-by-line processor's while loop and return to process the same ” character. Upon return, catchup is reset to false (FIG. 2) before entering the loop. The ” character is next processed, with tokenization known to be complete up to the character. The token stream is then looked up along with any under construction token and the output buffer to determine if a # and include context exists for the string being opened. If so then a header name is processed, else the string rule applies. Note that in this method, the token recognition work for # and include is done by the responsible stage only and not duplicated as waste work in the first stage.

FIG. 3 shows the join stack lookahead pre-processing carried out as a preamble to the line-by-line processor in the same stage. For a line or line chunk that is read in, the first clause reacts to an ongoing join stack (i.e. the present line or chunk is preceded by a sequence of \s and an optional lesser number of newlines; this is indicated by a non-NULL value of join stack beginning) by checking for a newline as the first character. If so then the count of newlines is incremented (in join mask count) and if the same has become equal to the number of \s (given by join mask size), then the join stack is concluded by resetting join stack beginning and tokenizing the join stack as a display token (in save join mask( ). The clause returns from the procedure, indicating that the line/chunk processing is over (the line/chunk, a newline alone, has been consumed by the join stack).

If for an ongoing join stack, the first character is not newline, then there are two cases to consider. These cases are triggered in the second clause (Join stack conclude clause) in the figure. In the first case, if the ongoing join stack has at least one newline (join mask count >0), then the non-newline first character breaks the join stack and it is concluded by the consequent statement of the clause. Otherwise, if the first character is not \ or its trigraph equivalent (i.e. not bslash(loaded) is true) then the join stack is clearly not continued past the first character. In this case also, the clause concludes the join stack. The conclusion of a join stack in the clause also prints any extra \s in the stack that are not matched by newlines (join mask count). This is carried out by print unjoined mask( ), which returns true if it completes, or false, if it blocked by a full output buffer. In this case, the false value returned triggers a context switch by the procedure exiting (and not being reinvoked till the buffer has emptied). A context switch carried out thus also results in the stage remembering where to return to in the printing process later. This is done by recording an index into the unprinted \s in a variable called js printing index.

Thereafter, the start of a next candidate join stack is carried out by searching backwards from the end of the line/chunk for contiguous \s from the end, allowing for a newline character also at the end. This start is stored in 1p and a stopping point for the line/chunk is recorded in stop, that is either just past the last character of the line/chunk or at the beginning of an incomplete trigraph that comprises the end of the line/chunk. This partial trigraph is left for inclusion in the beginning of the next line/chunk to be brought in.

The second clause, concluding join stack as described above, has an escape hatch for a continued join stack if the first character is a \ (and join mask count ==0). In this case, the clause does not conclude the join stack. Otherwise, the first two clauses ensure that if control moves past them, join stack beginning has been set to NULL. When a non-NULL join stack beginning survives past these clauses, then clearly the join stack continues throughout the line/chunk if lp is found pointing to the first character (viz. lp equals loaded). Otherwise, there is a break between the incoming join stack and the next candidate join stack comprising of non-\ characters. In this case, the incoming join stack is concluded, plugging the escape hatch permitted by the second clause. The clause carrying this out omits save join mask( ) since this particular join stack has been discovered to be just a sequence of \s without a newline. So it is not a true join and is only printed to the output buffer.

As mentioned earlier, the print unjoined mask( ) calls can context switch when faced with a full buffer. Upon switching back when buffer is empty, the printing process is continued by the state stored in js printing index. A non-zero js printing index highlights this running mode for the stage. When running with a non-zero js printing index, we have from the pseudocode preceding each print unjoined mask( ) call, that join stack beginning is NULL. When code in FIG. 3 is re-entered after completed printing by print unjoined mask( ) (with all intervening context switches), the NULL value of join stack beginning pre-empts the re-computation of all clauses in the figure till the assignment statement setting js printing index to 0. Stop and lp are computed, which means that if the print unjoined mask( ) was the second call in the figure, then in the printing process and context switches, stop and lp are computed twice before control reaches the js printing index=0 statement. This re-computation is stateless and may either be ignored, or disabled by the second call to print unjoined mask( ) flagging a boolean variable that leads to this effect. Regardless, the print unjoined mask( ) calls with context switches may be viewed as concluded after js printing index=0 is reached.

Next if js stack beginning has survived as non NULL, then we have that the join stack is a continued one and hence earlier join stack beginning is set to true, indicating that the beginning is from an earlier line/chunk. This is used in the last line in the figure, to exit the procedure instead of continuing on to the line-by-line processor code, FIG. 2, i.e. there are no characters in this line/chunk for the line by-line processor to work on.

In the intervening code between the setting and use of earlier join stack beginning, first a new join stack is initiated if one is present i.e. 1p points to \ or its trigraph equivalent (indicated by a true value of bslash(lp)). Next this new join stack, or the earlier continued one is built up in a while loop that records whether each encountered \ is just a character or a trigraph. This recording creates a bit mask as long as sequence of \s in the join stack. The loop advances lp past each character or trigraph (incremented by 3) as it progresses. Next, if lp ends up pointing to a newline after the loop, then the newline is committed to the join stack and recorded as such (by join mask count). If there is only one \ in the join stack, i.e. join mask count == join mask size, then the join mask is concluded and tokenized using save join mask( ). The associated setting of join stack beginning to NULL is left to be carried out after the line-by-line pre-processor loop, FIG. 2, later.

As in FIG. 2 and elsewhere, FIG. 3 is simplified by omitting straightforward details such as location tracking in the source code. These are straightforward to carry out in an implementation of the system.

At end of file (EOF), the following error conditions are checked by the first stage and rectified.

Incomplete Long Comment

A comment with a starting /* but not a closing */ before EOF causes the insertion of */ in the input code text along with a display modifier token for the same. A newline is inserted similarly, with display modifier, after the */.

Incomplete String, Header, or Character

The closing ”, ’, or > are inserted along with display modifier, followed by a newline insertion with display modifier.

Missing Newline

If the file ends without the mandatory newline, it is inserted along with a display modifier.

Incomplete Join Stack

If an unconcluded join stack is encountered at end of file, then it is first broken with a non-newline character, such as space, followed by a newline insertion to complete the file. A display modifier for the two character insertion is also created. The join cannot simply be closed with a newline insertion since it may simply add to the size of the join stack as another newline within it. After the join stack is broken, its treatment for saving the join stack token and printing unused \s follows the treatment given in the consequent part of the join stack conclude clause in FIG. 3.

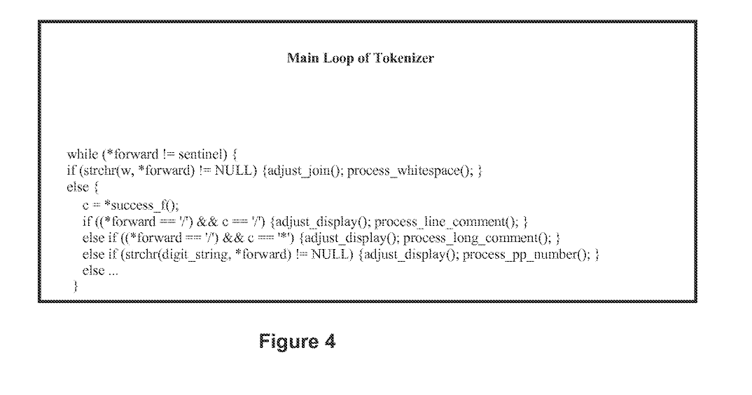

FIG. 4 shows the main loop of the tokenizer stage. The tokenizer runs in a while loop till end of file is encountered, identified by a sentinel character (a sentinel character is not present in the source character set [1]) placed in the buffer by the first stage. Rules are invoked for different lexical classes in the loop using constant-character buffer lookup. A first character is obtained by dereferencing forward (*forward) and its successor character is c=*success f( ). The comment rules shown tokenize comments using this two character lookup and a number rule is triggered upon finding a digit as the first character. Similarly other rules are placed in the tokenizer loop. Upon entering a rule, an adjust display( ) call starts collecting the display tokens created by the first stage that are pertinent to the token under construction, so that these tokens can be placed in the token stream in order with the lexeme tokens for easy lookup. One organizing principle is to put the display tokens for a lexeme right after the lexeme, followed by a next lexeme and its display tokens and so on. The adjust display( ) call starts collecting the tokens with the present character onwards (e.g. a preceding join, or the character being a trigraph, etc.). After this call, the process function for the rule is invoked and then the main loop continues.

In the tokenizer loop, during successor character lookups (success f( )) or forward pointer advances, the tokenizer can find itself reaching the filling point signifying that the buffer is empty and that it must block. When this happens, the tokenizer context switches by a call that invokes the first stage.

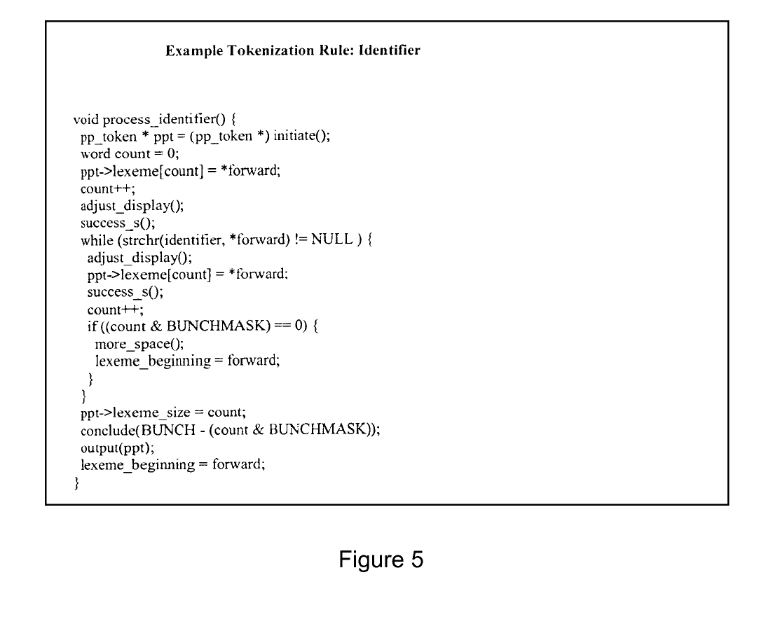

FIG. 5 shows the rule body for identifier as an an example of tokenizer rules. An identifier may be a long lexeme, so this rule is indicative of their treatment. In the rule, the call to initiate( ) invokes the collaborative allocator to allocate initial space for the lexeme under construction. Count tracks the number of characters stored for the lexeme and success s( ) calls advance the forward pointer in the buffer. Adjust display calls collect the modifiers for the token if they exist. The while loop progresses through the identifier characters (context switching back and forth in success s( ) calls as needed). If count grows to equal BUNCHMASK+1=BUNCH, which is a power of two and less than the size of the buffer, then more space( ) is called, which increases the space allocated to the token by the allocator. Lexeme beginning is moved next to point to the forward pointer in the buffer so that the first stage can continue filling the buffer behind the shifted pointer. Finally, conclude( ) returns the excess space left unused in the token back to the allocator. Output( ) places the token in the token stream along with the display tokens collected by adjust display( ) calls and lexeme beginning is adjusted to point past the lexeme in the buffer. Assignment of token fields other than size is omitted from the figure for conciseness.

Tokenizer rules may also create and add display tokens to the token stream on their own. For example, the rule for numbers inserts a missing sign character if it finds the omission along with a display token for the same.

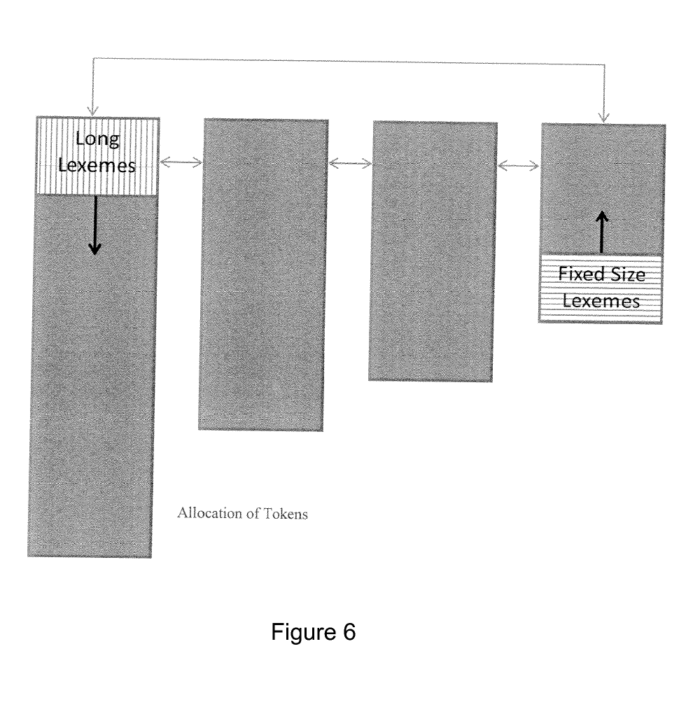

FIG. 6 shows the working of the collaborative space allocator. The allocator is organized as a circular, sorted (by size) list of memory blocks from which space allocation occurs. The head of the circular list points to the largest block and by traversing the head's previous link, the tail of the list can be obtained, which points to the smallest block. The allocation of long lexemes occurs from the largest block, to allow the lexeme maximum growth opportunity before running out of space. The allocation of small lexemes (i.e. fixed size lexemes) occurs from the smallest block that can serve the purpose. Thus the allocation of the lexemes proceeds from opposite ends of the memory blocks. After an allocation is carried out, the list is reordered if necessary to keep it sorted by size. Searching and shifting the block (deletion, insertion) is eased by the circular arrangement of the blocks (e.g. the search loop uses a single-predicate test).

In case of a large program, memory can run out when the two allocation ends cross each other. At any time, there is only one long lexeme under allocation. Hence the two ended allocation scheme works well without conflict. In case two a priori-unknown-size allocations need to carried out together, the allocator does not know where to start the second allocation from in the largest memory block. Any choice of the second starting position reduces the degree of freedom for the first allocation. Hence the design of Magic, with one long lexeme at a time helps make the allocator work optimally for long lexemes.

The display token for a join stack, representing the sequence of \s as a bitmask that identifies each \ as a character or trigraph is handled differently than long lexemes from an allocation perspective. This is because a join stack allocation may occur during the time a long lexeme is under construction (the lexeme may span both ends of the join stack) and hence two unknown-size allocations end up being needed simultaneously from the allocator. This is undesirable, given the discussion above. Further, a join stack is not a lexeme or as common as one. So a join stack token is not treated like a long lexeme from an allocation perspective. For a join stack, for collecting the bitmask, a sequence of fixed size allocations is carried out. Once a bitmask is complete, it is shifted from this temporary sequence to a known-size token of the appropriate size as another fixed-space allocation. The sequence of allocations for collecting a bitmask is never de-allocated. It is kept as temporary memory committed to collecting bitmasks throughout the program. The size of this temporary space grows to equal the largest bitmask in the program and no more. Thus this committed extra space is an ignorable expense that when amortized over program input (join stacks), is bounded by a small-constant linear expense over program size.

An alternative to using display modifiers/tokens in the system is to store each lexeme's print representation in its token along with the lexeme representation. This alternative may be implemented as one embodiment of the teaching presented herein, but this alternative suffers from the following undesirable attributes.

(i) Regardless of the number of display issues, the space for each token may be doubled, since the lexeme is represented once as itself and once as its print version including joins, trigraphs etc.

(ii) More importantly, a long lexeme now has two apriori-unknown allocations to handle, one for the lexeme and one for the print version.This compromises the scheme quite substantially.

(iii) Finally, in a symbol table, a lexeme e.g. identifier, is commonly shared by its many occurrences in source code. Each occurrence may have distinct display issues, but the lexeme is shared. This is straightforward to implement in the teaching presented here. The display issues remain orthogonal, captured by the display modifiers on an occurrence by occurrence basis. If the lexeme is tied to one print representation, then this sharing is complicated.

The concurrent stages with inexpensive context switching presented here may be implemented on parallel or sequential machines (e.g. multi-core processors) as concurrent pipelined stages or as a single merged stage with one constant-space buffer comprising the line-by-line processor and tokenizer merged together. This merged stage would have the additional feature of join-stack lookahead pre-processing as described. The choice of the specific implementation would depend on tradeoffs made in favour of higher and simplifying parallelism with simple stages and simple buffers versus copying cost across buffers. Further parallelism may also be obtained by separating the file reading code that fills the input buffer as a separate stage.

Highly Concurrent Implementation

The presentation of Magic thus far, has focussed primarily on a serialized implementation of a concurrent specification. In this section, we describe its highly concurrent implementations on a variety of parallel machine models. All the implementations (including the serialized one previously) are wait-free and use no synchronization constructs or primitives, relying exclusively on atomic registers or less in the underlying machine memory for implementation.

Unlike the classical approach of highly concurrent, lock-free object implementation in literature, our work does not duplicate work such as repeated copying of data structures.

Indeed, work assigned to a stage is computed exclusively by the stage and not duplicated redundantly by another stage. This obtains for us a very high efficiency in contrast. Furthermore, all of our work relies on single-writer, multi-reader atomic registers or single-writer single-reader registers for implementation. This is less of a requirement or power than all the operations or synchronization primitives or synchronization constructs reported in the consensus hierarchy ranking them by their synchronization power. Synchronization constructs that are not wait-free are of course not pertinent or used in our work.

In summary, our system is designed to ensure wait-free progress in handling and processing its input with very high efficiency and implementability on a variety of computing platforms. Thus our system is highly capable of independent or mobile/embedded/componentized use with a very lightweight footprint in the computing milieux.

In furtherance of the above capability is the progress-making or tolerance capability of our system in handling all syntactic input program text/errors. This includes not classifying input syntax as error by imposing arbitrary translation limits.

In a highly concurrent realization of our system, the input file reader stage may be a part of the line-by-line stage or separate. Regardless, the file reader has private access to the file pointer while reading the file from end to end. In processing a translation unit, multiple included files may have to be read, the names of which are communicated to the file reader by a separate channel for the purpose. This channel is comprised of a stream of file records that are created by a later stage, a directives processing stage (see FIG. 1) that recognizes the #include directives (and does macro processing etc.). The directives stage works on the output of the tokenizer and among other things recognizes the #include directives and creates the file record for them. The file reader runs as an independent thread, starting with reading the input file, followed by watching this stream and reading each new in-coming file to the end. For each file, the file reader populates the input buffer as usual. Before overwriting an existing entry in the buffer, the file reader watches the position of loading point in the circular buffer. A line is written if loading point is past the line else it is not. Loading point, an atomic register, has the line-by-line stage as the exclusive writer and the two readers for it are the file-reader and the line-by-line stage. The line-by-line stage watches similarly for the writing position of the file reader before advancing loading point through a line. This is carried out by a line number announced by the file reader, till which the buffer has been filled. The line number atomic register is written by the file reader as the sole writer and read by the line-by-line stage as a second reader.

The stream of file records has multiple readers besides the file reader and the directives processor. The tokenizer after finishing tokenizing a file reads the file reader for the next file it has to tokenize. For this purpose it reads and moves along the file stream in the process of tokenization (head to tail). The reading process involves no writes and the read data is written exclusively by the directives processor (single-writer, multi-reader). When it finds a file to tokenize, it begins constructing the token list for the file and writes the head and tail of the token list in the file structure. This writing of the two slots in the file structure is owned exclusively by the tokenizer and the other processes are readers of these slots only (atomic registers). Thus the writer for the file records data is determined by the positions/offsets in the records. The buffer between the line-by-line stage and the tokenizer remains as before, except for implementation as 1-writer 2-reader atomic registers of the buffer pointers. The buffer is written by the line-by-line stage and read by the tokenizer and the line-by-line stage. The data dependencies ensure that no writing of a buffer position occurs in concurrence with the reading by the tokenizer, so 1-reader, 1-writer implementation of the buffer itself suffices. As regards the buffer pointers, filling point is written exclusively by lineby-line, and lexeme beginning and forward are written exclusively by tokenizer.

The directives processor overwrites the tokens list generated by the tokenizer for a file, e.g. deleting directives after processing them. The overwriting remains behind the tail of the token list and hence remains a 1-writer process on the concerned tokens. The overwriting involves token insertions (e.g. in macro expansion), which makes the overwriting process difficult to carry out with the desired atomic registers. We present three options for the purpose below. It is to be noted first that deletions (e.g. directives) are not carried out by actually removing the tokens from the list. The deleted tokens are simply marked as deleted in a status field for the tokens. This is needed to ensure that comprehensive program information is kept for all stages (e.g. pretty printers, which may print the original directives and macros and not the processed results). With this, the modifications to the list comprise at most insertions and status modifications with directives processor as the exclusive writer in the process.

1. The token list is kept singly-linked, so that an insertion simply involves one register overwrite. This can be carried out atomically with single-writer, multi-reader concurrency, with a reader either obtaining the linkedlist view prior to the insertion, or thereafter. This may be enough for some of the processes e.g. pretty printing the original file (macro expansions not needed).

2. The directives processor announces its present position in the list with all modifications concluded prior to the position using a 1-writer multi-reader atomic register. The other readers read the register and stay behind the directives processor in handling the tokens. In the case of option 1 above, the readers not needing this information can proceed ahead independently.

3. The token list is kept doubly-linked, so two separate next and prey fields require modification in one atomic write. This is not possible using atomic registers alone. Note however that the directives processor carries out only one insertion at a location. A later insertions is distanced from the first by intervening tokens. Hence the doubly linked structure can be updated using atomic registers as follows. The insertion updates the next link atomically and this counts as the completed insertion. The information in the prey field is considered un-reliable and not used by other readers without further checking For a given insertion, the following <next, prey> sampling scenarios are possible: <earlier, earlier>, <earlier, updated>, <updated, earlier>, <updated, updated>. If <earlier, earlier> or <updated, updated> values are sampled, then the next and prey fields are consistent with each other and the tokens point to each other. So if a reader simply checks its sampled values for consistency, it is assured that either it has sampled the token list prior to the insertion, or thereafter and not in-between.

Theorem 1. A token list reader reads a superset of the tokenizer tokens in a concurrent list traversal.

PROOF. As stated, an insertion by the directives processor is either read after the fact or completely missed. This is the case for the methods 1 and 3 above. Hence at most a subset of the insertions are seen. Since there are no token deletions, the reader finds the insertion subset and tokenizer tokens in the traversal, which comprise a superset of the original tokens. For method 2, all the insertions are seen, which again means that a superset is seen.

Remark A reader can hibernate, which means it can continue with its traversal after a very long time. This means that the token list has to be kept around perpetually and not reused for other purposes when the reader resumes reading. Hence oblivious garbage collection is ruled out. Space reclamation is discussed further later.

A #include directive in a file's token stream is marked as deleted. The corresponding token stream in its file record can be deleted from the record and inserted after the directive, but this brings up token deletions, which are avoided in our monotonically increasing structures approach. Thus the deleted directive is used by token readers to shift to the file's record structure for reading its tokens prior to returning to the deleted directive for continued reading of its stream. No token deletions are involved.

As mentioned earlier, display tokens are created for display peculiarities and error-correcting insertions in the input program. In the serialized implementation, one display token, sign insertion for number rule, is created by the tokenizer stage. All the other display tokens are created by the lineby-line stage. For a highly concurrent implementation, this creation process is shunted entirely to the line-by-line stage, so that the creation process becomes single writer. The single writer can be viewed as creating an endless stream of display tokens, and writing the head and tail pointers to the stream. This stream is read by a second reader, the tokenizer, to arrange its token stream. As mentioned earlier, a simple arrangement is to collect display tokens for a given character and place such a collection after the character's lexeme in the token stream. This arrangement removes the tokens from the token stream created by the line-by-line stage and places them in the tokenizer output. For this removal activity to proceed safely in concurrence with the creation activity, the following technique is used to keep a distance between them so that both can proceed as single writer activities. A marker token is inserted after the display tokens pertinent to a character so that the token stream created by the line-by-line stage comprises display tokens partitioned by marker tokens. The tokenizer stage goes past a given marker only if it finds that the line-by-line stage has moved past the next marker. The line-by-line stage announces its latest marker by a 1-writer 2-reader atomic register for the purpose. Since display tokens for a program may be few, non-reused markers suffice for the implementation of this scheme. If reuse of markers is desired, it suffices for the tokenizer to also announce the latest marker it has gone past similarly, so that the line-by-line stage can reclaim earlier ones.

The allocator is used by the tokenizer to create tokens. The line-by-line processor uses it to create display tokens and the directives processor uses it to create tokens for macro expansions etc. In the serialized implementation, this is a non-issue; however in a highly concurrent implementation this cannot be carried out naively without contention. The allocator is thus modified as follows to make it highly concurrent: The tokenizer is made the exclusive writer for allocations. The other processes await fixed chunk allocations from the tokenizer from which they can then carry out their own internal allocations. This scheme compromises longlexeme allocations outside the tokenizer, but this is acceptable, given the observation that the only long lexeme demand from outside comes from the directives processor during macro processing for constructing what we call as macro explanations in our system. A macro explanation is a long comment that lists the expansion steps of a macro invocation, such as argument expansion, substitution in the macro body, etc. During macro expansion, such a comment is also constructed and inserted after the (deleted) macro invocation. A macro explanation is built using a long lexeme since a macro can be arbitrarily large. Being a long comment, a macro explanation is breakable into multiple adjacent long comments. Thus the long lexeme construction of a macro explanation can be broken into multiple long lexemes to fit fixed chunk allocations. In general, the fixed-lexeme allocations requested by non-tokenizer stages are small in size and hence the fixed chunk scheme detailed here works well. The tokenizer uses a buffer (similar to others in our system) to send chunks to others. A chunk comprises a pair of locations demarking the ends of the chunk. A stage receiving a chunk is free to be the exclusive writer in the space of the chunk. The tokenizer is free to manage the rest of the allocator internals sequentially. In general, the tokenizer endeavours to keep the chunk allocation buffers full as far as possible. The consumers empty the chunk buffers and the tokenizer fills them. For long-lexeme allocations, the chunks are preferably contiguous, but the tokenizer's own long-lexeme needs may cause interleaving of allocations, thereby breaking the contiguity of chunks sent to others. In general, this producer consumer pipe of allocations works well and does not require consumers to actively raise demands for allocations using sought allocation sizes. There is however the possibility of an exception, such as a huge join stack, requiring a huge display token. In this case, using a separate pipe/buffer for raising the sought demand, the consumer can communicate its need to the tokenizer and the tokenizer responds in kind returning a matching fixed chunk on another return pipe. The pair of demand/return pipes are extra and separately kept between the tokenizer and consumer pairs.

It may be noted that the above allocator maintains the two boundary optimum nature of the core allocator with sorted memory blocks precisely as is. Each block is consumed fully, no wastage, as the chunks sent to the consumers can be variably sized. Indeed because of the breakable nature of the macro explanations, the chunks sent for the purpose can take odd sizes also and effectively use space at the end of blocks. The buffer for such chunks can be filled thus, with more space( ) demands being fulfilled one at a time, to interleave the tokenizer's own needs.

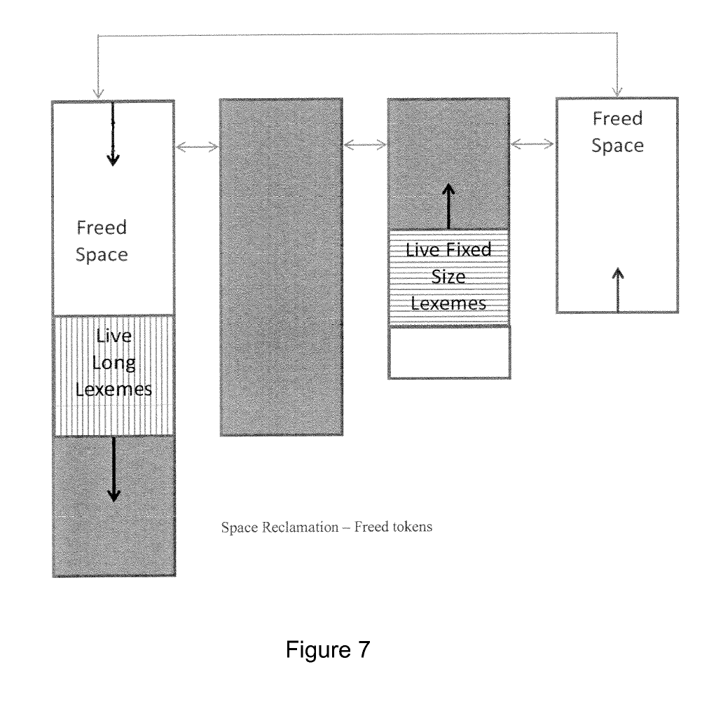

In the serialized implementation, space reclamation for the allocator can be carried out as follows. A notion of consumption or archival of a token has to be defined, post which the token space can be reclaimed. A simple notion for this is writing to file. For example, the token stream can be written out as token structures to a file for passing on to other users that can work with the file. A token can be written out/archived after all concurrent readers for it have finished their use of it. Since the token stream for a translation unit (all files) has a well-defined sequence, the stages can straightforwardly be scheduled (and de-scheduled) to produce tokens according to the sequence. So for instance, once a #include line is processed, the current file processing can be descheduled across the board and the included file processing begun. The progress of all stages through the sequence can be kept balanced, with position pointers of the stages tracked in the sequence. The tokens passed by all stages can then be archived and their space reclaimed. In this mechanism, since token allocation occurs according to the followed sequence, the reclaimed tokens comprise a contiguous block of released space, simplifying the space management significantly. In order to ensure this, the memory allocations of the directives processor have to be carried out from two distinct pools/blocks. Macro expansions generate regular tokens, so their space release follows the translation sequence and hence can be allocated as described so far. The other space allocations by the directives processor e.g. file records, list of collected macro definitions, make up longlived allocations that may not be de-allocated till the end of the translation unit. These long-lived allocations have to be distinguished from the others in terms of the originating blocks so that the token de-allocations free up contiguous space, un-fragmented by the long-lived allocations. In the context of the highly-concurrent implementation the same swapping out to secondary storage can be done, with barriers ensuring the balanced progress of stages through the translation sequence. For example, the tokenizer can monitor the single-writer, multi-reader position pointers of others and block its own progress to enable a lagging stage to catch up. The reclamation of space behind the position pointers is sequentially managed within the allocator internally, straightforwardly as follows. Consider a policy that memory blocks are not re-sorted after initialization (i.e. after allocations), so that allocations occur in a fixed order starting from the two ends of the sorted blocks. If long lexeme fails to be completed at the end of a block, then it is re-attempted from the top of the next block and the space at the end of the first block left unused. Similarly fixed size allocations may leave unused space at the end of a block. In this fixed set of blocks, once tokens have been reclaimed, the reclamation defines starting positions of live tokens, at the two ends of the sorted blocks. The space prior to these starting positions has been reclaimed at both the ends. As computation proceeds further, the continued allocations and de-allocations move the long-lexeme allocation boundary towards the fixed-lexeme allocation boundary with the starting positions of live lexemes chasing these boundaries at each end. Once the allocation boundaries meet, the allocations are shifted to re-start from the two ends of the sorted memory blocks (like at start). The boundaries then start moving in again, like before. The starting positions continue chasing the boundaries, going as far as the meeting point of the allocation boundaries and then re-starting from the two ends. Thus this process continues over and over again in a cyclic manner. This movement is illustrated in FIG. 7.

Consider next a baseline implementation of the system on a parallel machine with only private memory per processor and inter-process communication with FIFO pipes. In this distributed memory model, the file reader simply passes the read lines for a file to the line-by-line stage using a pipe. The line-by-line stage processes its input pipe and writes to a pipe going to the tokenizer (one for circular buffer, one for display tokens). The tokenizer constructs tokens in its private memory and sends the token stream via pipes to all the readers e.g. directives processor. The line-by-line stage does not need the token stream from the tokenizer beyond pre-processing context, for which it can block its output, and send a pre-processing context request to the tokenizer which upon catching up complies. The directives stage copies the incoming token stream from the pre-processor in its own local memory and modifies it before passing on the same to all readers of the modified stream. In this implementation, the stages and communication patterns are quite fixed. This enables mapping the stages and pipes to the optimum communication/network pattern in a distributed/systolic machine, for leveraging locality and nearest-neighbour communication. For constant-space buffers, constant-space pipe implementations suffice. For others, e.g. token stream, the movement of data can be highly chunked by the following observation. The tokens are allocated in contiguous space by the concerned stage (e.g. display tokens in line-by-line, tokens in tokenizer in the two ends of the allocator). In communicating, the allocator progress can be tracked, sending the entire chunk of newly allocated contiguous space (since last communication) as one contiguous block over a pipe. If memories of all the processors are aligned, then no marshalling/unmarshalling of the communicated binary data is needed either. This bulks the communication, making it much cheaper. As will be noticed, the system presented here minimizes communication/network load for choreographing the shared memory computation in software over a disjoint memory processor network.

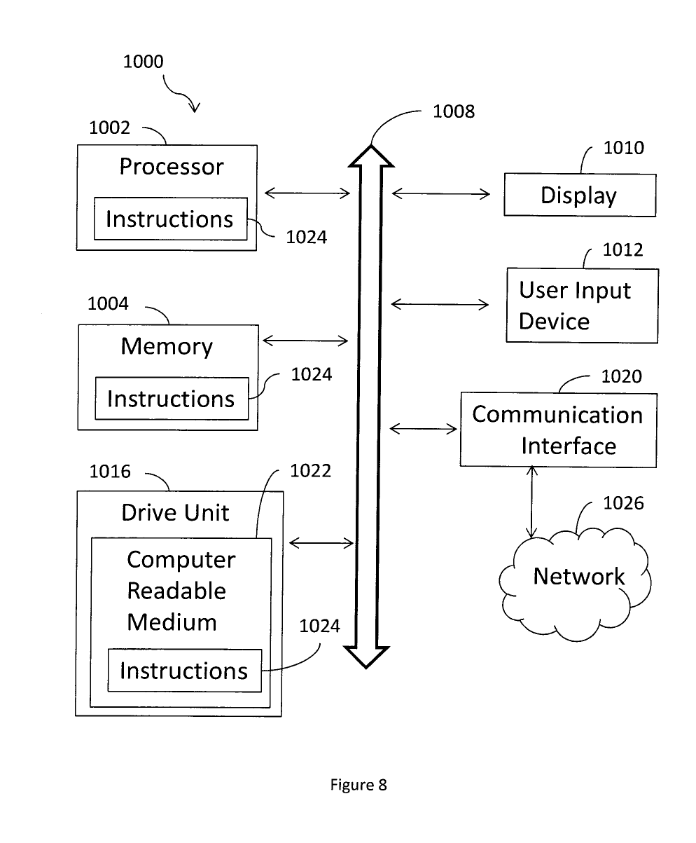

FIG. 8 illustrates a typical hardware configuration of a computer system, which is representative of a hardware environment for practicing the present invention. The computer system 1000 can include a set of instructions that can be executed to cause the computer system 1000 to perform any one or more of the methods disclosed. The computer system 1000 may operate as a standalone device or may be connected, e.g., using a network, to other computer systems or peripheral devices.

In a networked deployment, the computer system 1000 may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a control system, a personal trusted device, a web appliance, or any other machine capable of executing a set of instructions (sequential or otherwise) that specify actions to be taken by that machine. Further, while a single computer system 1000 is illustrated, the term “system” shall also be taken to include any collection of systems or sub-systems that individually or jointly execute a set, or multiple sets, of instructions to perform one or more computer functions.

The computer system 1000 may include a processor 1002, e.g., a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data The processor 1002 may implement a software program, such as code generated manually (i.e., programmed).

The term “module” may be defined to include a plurality of executable modules. As described herein, the modules are defined to include software, hardware or some combination thereof executable by a processor, such as processor 1002. Software modules may include instructions stored in memory, such as memory 1004, or another memory device, that are executable by the processor 1002 or other processor. Hardware modules may include various devices, components, circuits, gates, circuit boards, and the like that are executable, directed, or otherwise controlled for performance by the processor 1002.

The computer system 1000 may include a memory 1004, such as a memory 1004 that can communicate via a bus 1008. The memory 1004 may be a main memory, a static memory, or a dynamic memory. The memory 1004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1004 includes a cache or random access memory for the processor 1002. In alternative examples, the memory 1004 is separate from the processor 1002, such as a cache memory of a processor, the system memory, or other memory. The memory 1004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts or tasks illustrated in the figures or described may be performed by the programmed processor 1002 executing the instructions stored in the memory 1004. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1000 may or may not further include a display unit 1010, such as a liquid crystal display (LCD), an organic light emitting diode (OLED), a flat panel display, a solid state display, a cathode ray tube (CRT), a projector, a printer or other now known or later developed display device for outputting determined information. The display 1010 may act as an interface for the user to see the functioning of the processor 1002, or specifically as an interface with the software stored in the memory 1004 or in the drive unit 1016.

Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control or any other device operative to interact with the computer system 1000.

The computer system 1000 may also include a disk or optical drive unit 1016. The disk drive unit 1016 may include a computer-readable medium 1022 in which one or more sets of instructions 1024, e.g. software, can be embedded. Further, the instructions 1024 may embody one or more of the methods or logic as described. In a particular example, the instructions 1024 may reside completely, or at least partially, within the memory 1004 or within the processor 1002 during execution by the computer system 1000. The memory 1004 and the processor 1002 also may include computer-readable media as discussed above.

The present invention contemplates a computer-readable medium that includes instructions 1024 or receives and executes instructions 1024 responsive to a propagated signal so that a device connected to a network 1026 can communicate voice, video, audio, images or any other data over the network 1026. Further, the instructions 1024 may be transmitted or received over the network 1026 via a communication port or interface 1020 or using a bus 1008. The communication port or interface 1020 may be a part of the processor 1002 or may be a separate component. The communication port 1020 may be created in software or may be a physical connection in hardware. The communication port 1020 may be configured to connect with a network 1026, external media, the display 1010, or any other components in system 1000, or combinations thereof. The connection with the network 1026 may be a physical connection, such as a wired Ethernet connection or may be established wirelessly as discussed later. Likewise, the additional connections with other components of the system 1000 may be physical connections or may be established wirelessly. The network 1026 may alternatively be directly connected to the bus 1008.

The network 1026 may include wired networks, wireless networks, Ethernet AVB networks, or combinations thereof. The wireless network may be a cellular telephone network, an 802.11, 802.16, 802.20, 802.1Q or WiMax network. Further, the network 1026 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” may include a single medium or multiple media, such as a centralized or distributed database, and associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed. The “computer-readable medium” may be non-transitory, and may be tangible.

In an example, the computer-readable medium can include a solid-state memory such as a memory card or other package that houses one or more nonvolatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement various parts of the system 1000.

Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

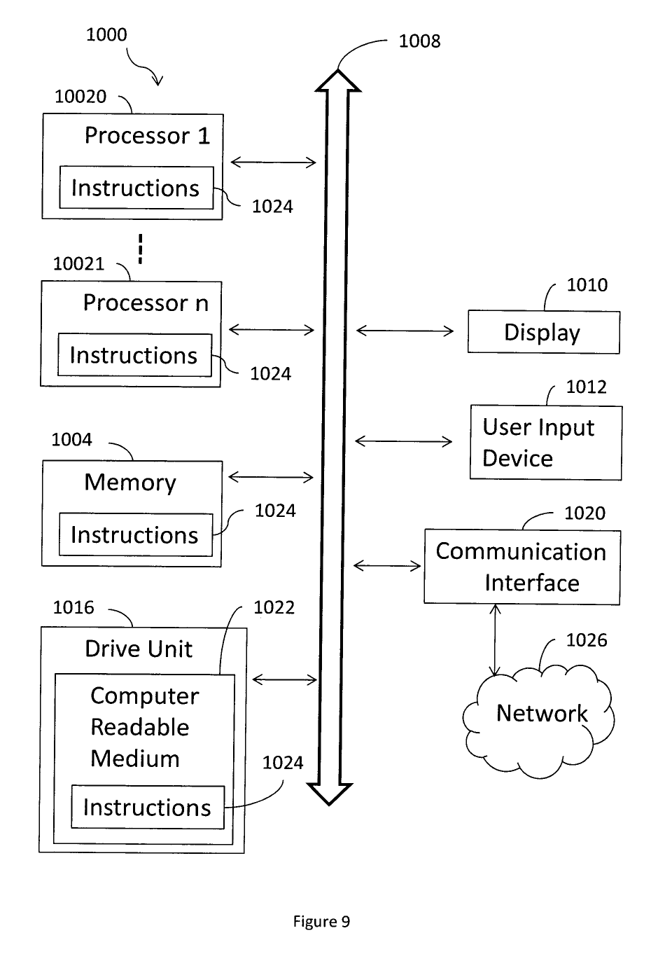

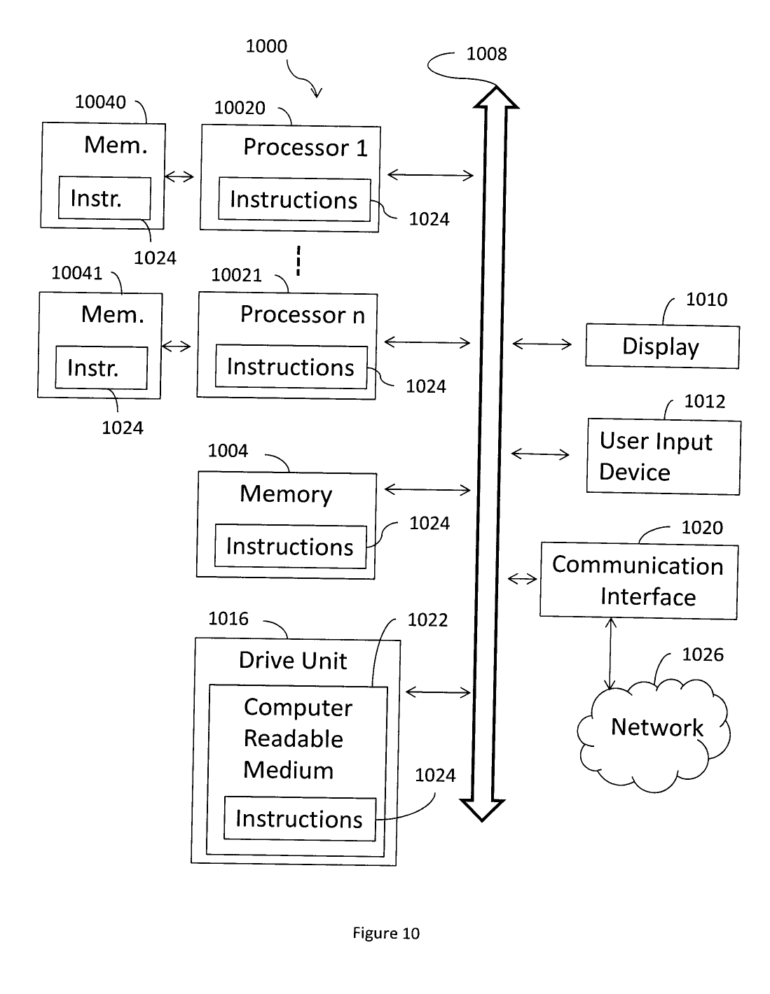

FIG. 9 illustrates a typical hardware configuration of a shared memory parallel computer system, in which the invention may be practiced. FIG. 10, similarly illustrates a typical hardware configuration of a distributed memory parallel computer system, in which the invention may be practiced. In FIG. 9, a plurality of n processors ranging from 10020 to 10021 are used. All the other elements of the figure are shared by the processors, such as the memory 1004, which is shared memory accessed by the processors. In FIG. 10, the shared memory unit 1004 is optional. The processors in FIG. 10 have dedicated private memory units numbered similar to the processors, e.g. memory 10040 for processor 10020. The numbering of units in FIGS. 8-10 overlaps so that the description of a unit for FIG. 8 above applies to its counterpart in a later figure. The description of a processor 1002 in FIG. 8 applies to the processors 10020-10021 of FIGS. 9 and 10. The description of memory 1004 in FIG. 8 applies to the shared (1004) or private memories (10040-10041) of FIGS. 9 and 10, as applicable.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature.

While specific language has been used to describe the disclosure, any limitations arising on account of the same are not intended. As would be apparent to a person in the art, various working modifications may be made to the process in order to implement the inventive concept as taught herein.

### REFERENCES

[1] A. V. Aho, R. Sethi, and J. D. Ullman. Compilers Principles, Techniques, and Tools. Addison-Wesley Publishing Company, Reading, Mass., USA, 1987.

[2] C. Standard. ISO/IEC 14882:1998 C++ standard, 1998. www.iso.org, 1998.

[3] C. Standard. ISO/IEC 9899:1999 C standard, 1999. www.iso.org, 1999.

[4] C. Standard. INCITS/ISO/IEC 14882-2011[2012] C++ standard, 2011. www.iso.org, 2011.

[5] C. Standard. INCITS/ISO/IEC 9899-2011[2012] C standard, 2011. www.iso.org, 2011.

[6] P. Varma. Generalizing recognition of an individual dialect in program analysis and transformation. In Proceedings of the 2007 ACM Symposium on Applied Computing, SAC '07, pages 1432-1439, New York, N.Y., USA, 2007. ACM.

[7] P. Varma. Anchored text for software weaving and merging. In Proceedings of the IEEE International Conference on Secure Software Integration and Reliability Improvement, SSIRI '09, pages 93-100, Los Alamitos, Calif., USA, 2009. IEEE Computer Society.

What is claimed is:

1. A concurrent, wait-free compiler/compiler front-end method, comprising parallel stages that carry out the steps of character translation, line translation, macro rewriting, lexing, parsing, and handling errors in input text and translating it to an object form.

2. The method as claimed in claim 1, wherein the method is carried out using constant-space buffers between stages and a memory allocator for allocating memory proportional to the size of the program input including expanded macros and included files.

3. The method as claimed in claim 2, wherein the method is carried out using constant memory for buffers and a recycling memory allocator.

4. The method as claimed in claim 3, wherein the method is carried out using constant memory for the stack and the method code.

5. The method as claimed in claim 1, wherein the method is carried out using only single-writer registers of parallel shared memory machines and no synchronization constructs.

6. The method as claimed in claim 5, wherein the method is carried out by monotonically increasing structures without node or token removals.

7. The method as claimed in claim 6, wherein the method is carried out using only registers of a uniprocessor machine and no synchronization constructs in a serialized implementation of the concurrent stages.

8. The method as claimed in claim 7, wherein the method is carried out such that context switches between stages are minimal and inlined in a serialized schedule.

9. The method as claimed in claim 1, wherein the method is carried out such that the concurrent stages can tolerate all syntactic input text errors and progress through the entire input to either translate it or report on errors.

10. The method as claimed in claim 9, wherein the method is carried out such that errors are minimized by not placing syntactic translation limits such as lexeme size or line length on the input.

11. The method as claimed in claim 1, wherein the method is carried out such that work per stage is unique and no redundancy or work duplication is involved.

12. The method as claimed in claim 1, wherein the method is carried out with minimal contention/communication realization on cached PRAM (parallel random access memory—shared memory) and all distributed memory models comprising first-in-first-out (FIFO) order data communication from a one-writer stage memory to a reader-stage memory in a static mapping of stages to processors minimizing communication cost.

13. The method as claimed in claim 1, wherein the method supports C/C++ and Java.

14. A compiler/compiler front-end method that carry out the steps of character translation, line translation, macro rewriting, lexing, parsing, and handling errors in input text and translating it to an object form where the entire input is represented in the object form including whitespace such as comments, display alternatives such as trigraphs and line joins, original directives and macros, and a record of error corrections.

15. The method as claimed in claim 14, wherein the method is carried out with unknown look ahead needs dealt with earliest in an initial stage of the compiler.

16. The method as claimed in claim 15, wherein the method is carried out such that the input can be regenerated from the object form in printing or pretty printing it.

17. The method as claimed in claim 14, wherein the method is carried out such that display alternatives and error corrections are tracked using display tokens.

18. The method as claimed in claim 17, wherein the method is carried out such that display tokens allow concurrent read and write by distancing single writers using marker tokens.

19. The method as claimed in claim 14, wherein the method is carried out such that deletions are implemented by marking a token or node as such instead of actual removal.

20. The method as claimed in claim 14, wherein the method is carried out such that all syntactic input text errors are tolerated and the method can progress through the entire input to either translate it or report on errors.

21. The method as claimed in claim 20, wherein the method is carried out such that errors are minimized by not placing syntactic translation limits such as lexeme size or line length on the input.

22. The method as claimed in claim 14, wherein the method is carried out such that unlimited-size long lexeme tokens are generated for syntactic constructs such as lexemes, whitespace and comments in which space allocated for a long lexeme is expanded contiguously as needed to represent the construct and a lexeme beginning pointer advanced through the construct so that lexeme recognition and tokenization takes place within a constant-space buffer.

23. The method as claimed in claim 14, wherein the method is carried out such that pretty printing or printing of the processed input is carried out after each translation step so the progress of the input step-by step can be displayed with a comprehensive printing of the entire input.

24. The method as claimed in claim 23, wherein the method is carried out such that macro processing of any set of macro invocations in the input is displayed step by step.

25. The method as claimed in claim 24, wherein the method is carried out such that macro processing steps are printed as a comment represented in a long lexeme called a macro explanation, broken into multiple long lexemes on demand.

26. A concurrent, lock-free compiler/compiler front-end method, comprising parallel stages that carry out the steps of character translation, line translation, macro rewriting, lexing, parsing, and handling errors in input text and translating it to an object form.

27. The method as claimed in claim 26, wherein the method uses only single-writer registers of parallel shared memory machines and no synchronization constructs.

28. A wait-free concurrent allocator supporting apriori unknown-sized contiguous-space allocations and fixed-sized contiguous-space allocations, wherein an unknown sized allocation is carried out by an initial space allocation, an optional sequence of continued more-space requests, and an optional return excess space request.

29. The allocator as claimed in claim 28, wherein the allocator is organized as a list of memory blocks sorted by size, with unknown-space allocations starting from the top of the largest end and fixed-size allocations starting from the bottom of the smallest end.

30. The allocator as claimed in claim 28, wherein the allocator is implemented using only single-writer registers of parallel shared memory machines and no synchronization constructs.

31. The allocator as claimed in claim 28, wherein the allocator is organized with one concurrent stage implementing the allocator function and allocating chunks to others.

32. The allocator as claimed in claim 28, wherein the allocator supports bulk concurrent recycling of unknown-size and/or known-size allocations such that contiguous space behind live allocations is freed up and a recycling boundary chases an allocation boundary around the sorted memory blocks for each kind of allocation (known/unknown size).

33. A concurrent, wait-free compiler or compiler front-end system operable in a computing environment comprising parallel stages with means for character translation, line translation, macro rewriting, lexing, parsing, and handling errors in input text and translating the input to an object form.

34. The system as claimed in claim 33, with minimal contention or communication realization on cached PRAM shared memory machines and all distributed memory machines comprising FIFO order data communication from one-writer stage memory to a reader-stage memory in a static mapping of stages to processors minimizing communication cost.

35. A serialized compiler or compiler front-end system operable in a computing environment with means for interleaved execution using a uniprocessor and sequential memory without explicit synchronization constructs of parallel compiler stages that carry out character translation, line translation, macro rewriting, lexing, parsing, and handling errors in input text and translating the input to an object form.

36. A compiler or compiler front-end system operable in a computing environment comprising means for character translation, line translation, macro rewriting, lexing, parsing, and handling errors in input text and translating the input to an object form where the entire input is represented in the object form including whitespace comprising comments, display alternatives comprising trigraphs or line joins, original directives, macros, and a record of error corrections.

37. The system as claimed in claim 36, further comprising a means for unknown look ahead of input early in input processing.

38. The system as claimed in claim 36, further comprising a means for generating unlimited-size long lexeme tokens for syntactic constructs comprising lexemes, whitespace and comments such that space allocated for a long lexeme is expanded contiguously as needed to represent the construct and a lexeme beginning pointer advanced through the construct so that lexeme recognition and tokenization takes place within a constant-space buffer.

39. The system as claimed in claim 36, further comprising a means for printing or pretty printing the input after each means such that progress of input processing can be displayed with a comprehensive printing of the entire input.

40. The system as claimed in claim 39, wherein processing by a means is represented by a comment comprising one or more lexemes or long lexemes including macro explanations.

41. A compiler or compiler front-end system operable in a computing environment comprising a means for unbounded character lookahead in input text for complete processing of line joins of the ANSI/ISO C/C++ language standards.

42. The system of claim 41, further comprising a means for representing the entire program input in the system output, wherein the program input may comprise line joins comprised of combinations of ordinary and trigraph characters.
